(19) United States
(12) Patent Application Publication
(10) Pub. No.: US 2002/0116211 A1
(43) Pub. Date: Aug. 22, 2002

(54) Method for investment management

(76) Inventor: Eiichi Hatakeyama, Tokyo (JP)

Correspondence Address: Venable, P.O. Box 34385, Washington, DC, 20043-9998, US

(21) Appl. No.: 10/046,709

(22) Filed: Jan. 17, 2002

(30) Foreign Application Priority Data
Jan. 18, 2001 (JP) 2001-45776
Apr. 19, 2001 (JP) 2001-157883

(51) Int. Cl. G06F 17/60

(52) U.S. Cl. 705/1

(57) ABSTRACT

A method of investment management of the present invention creates the new logic and the new market mechanism of capital by incorporating the basic principle of capitalism into a venture business. It provides a third financial intermediary function “structured finance” with a novel concept of an indirect investment responsible for the supply of funds to the industrial world. Profit growth increases two or five-fold if the fund investments are turned over 2 to 5 times, resulting only in the accumulated increase in the number of invested target companies and the amount of investments. Thus, both an investment principal risk and a reinvestment risk can be decreased without limit. The present invention provides a novel mechanism that allows an asset securitization for circulating funds to cope against both reluctance of a bank to lend funds and unliquidation of investment capital and assets, so that the earning capacity can be strengthened.

This application is based on patent application Ser. No. 2001-045776 filed Jan. 18, 2001 and 2001-157883 filed Apr. 19, 2001 in Japan, the contents of which are incorporated hereinto by reference.

### BACKGROUND OF THE INVENTION

1. Field of the Invention

The present invention relates to a method for investment management, especially to a structure (mechanism) of the way of liquidation, a method of making an investment in a new business using the function of financial conversion specific to private trust business laws and a method for running a securitization business of liquidated property.

2. Description of the Related Art

Non-liquid finance and assets in financial intermediatory organization, such as a failure of financial circulation system referred to a blood of business activities and the bad debt problems of the bank, prevent the business recovery and become a cause of economic straits. Banks' reluctance to lend moneys to the medium and small companies has been unchanged in spite of introducing enormous amounts of taxpayer money for getting the banks under finance crisis squared away. In particular, medium and small venture companies have extreme difficulty raising funds, so that investments in research and development venture companies and manufacturing industries are in the midst of natural perishment because of the non-liquidation and inefficiency of fund management by venture capitals. In addition, non-liquid capital invested that takes a long time to realize capital gains and the decreased efficiency of venture capital's fund management are factors of preventing the investments in venture companies.

Consequently, investments are concentrated only on high tech business enterprises such as information technology-related companies that can be expected to be going public at an early stage, so that the capital markets are extremely unstable and risky as the investments in the venture businesses (VBs) tend to become speculation. One of the reasons of such a scene is the investment form itself depending on a current stock standard system. That is, there is a minimal possibility that a company being invested grows to go public over-the-counter for its stock and also targeted assets for investments are substantially limited to the mutual transaction between stocks and invested capital. In addition, the invested capitals are fixed and non-liquid, and the earning chances of cash flows are limited to only an exit at the time of going public on the over-the-counter market.

However, it is difficult to be aware of the difference between the terms of “investment” and “speculation”, which are almost interpreted synonymous words in the art, so that it is generally difficult to define the problem itself. The original meaning of “investment” is the pursuit of profit for the long term. These terms are interpreted differently from each other with respect to their original standards and targets for investment, so that it is formidable to provide them with the same meaning. The confusion with “investment” and “speculation” manifests itself in any discrepancies of understandings and expectations between entrepreneurs who desire capital investments (financial contributions) and investors who expect speculative profits (capital gains) is also, becoming a cause of unstable market.

Thinking back to old days of capitalistic economy, U. S. Government admirably brought out economic reconstruction by a package of economic policies known as “Reganomics”, in spite of having two financial deficits in the 1980s, with the contents of rebuilding the financial system, deregulation, reforming taxation system, privatizing public work projects, protecting intellectual property rights, and so on. The Reganomics is a vivid contrast to New Deal program of the 1930s. We can catch a glimpse of the pride and intention of the capitalistic state that the misguided policies of New Deal will never be repeated again, so that it is easily imagine that the United States references its own history as an example of how not to repeat the errors of New Deal program.

The Great Depression caused by the crash in 1929 in the United States had busted up by the financial crisis in 1933. Roosevelt who had elected to the presidency of that time declared that his first work was to resume all solid banks in Congress and carried out government financing to rescue the banks from financial difficulties. As was evident from New Deal depression, however, the bank bailout policy could not resolve banks' reluctance to lend in spite of the government's capital injection to banks. In this case, furthermore, any counter economic policies could not improve economy, so that more people were out of work as the recession had deepened.

Public money sprinkling policy that promotes public works for boosting the economy and bringing down unemployment in the New Deal depression period described above was thought to be a temporary policy until the time came when “private investments would become active”. However, the public works with the government financial investments was extended as the inflation policy activated, and then its character was changed from a temporary stimulative measure to a sustainable one. However, despite desperate efforts to reform the economy by the state monopolistic capitalism which is composed exclusively of various policies, the business recovery had not been emerged until the world war in 1939. After all, only the military procurement boom of world war restored the economic conditions.

As described above, fundamental factors of prolonging the New Deal slump was the limit of bank credit intermediation, i.e., banks' reluctance to lend and the problem of unemployment. By the way, it is noted that there are fundamental factors in Japanese economic depressions of recent years, which are in common with those of the New Deal slump. Currently, for example, standard concepts of what public works projects should be have been regarded as a problem because of enormous amounts of budget deficits of Japanese government. Creating new venture enterprises will be more effective than public works projects provided as counter economic and unemployment policies to cope with the problems of unemployment and the economic reconstruction as they will create jobs for more workers. For the creation of new venture businesses and the resolution for banks' reluctance to lend, furthermore, it is considered that the development of new structured finance system (so called third intermediation role) may be most important, which can allow for easy risk-takings in stead of bank's financing and venture capital's financing.

Heretofore, financial assets of households do not move towards risk-takings because the individual investors well recognize that unsoundness of financial institutions with intermediation roles for asset management, based on their experiences in collapse of bubble economy, due to dramatic fall in stock prices, and so on.

Rearing of entrepreneurs is indispensable in creating venture businesses, so that rearing of individual investors is equally indispensable in bring up entrepreneurs. Therefore, the increase in the number of entrepreneurs is correlated with the increase in the number of investors. In this case, however, there are always demands for investing funds for asset management on one hand, and raising funds for running businesses on the other hand, so that any problems may be summarized into a structural problem for matching these demands. A new financial intermediation mechanism has to be established for easily expediting the raising of funds for entrepreneurs together with the avoidance of risking the possibility of losses for investors. Therefore, the need for the new system on which variations in economic activities and stock prices fluctuation have little effect, is increasing. Such a system may have its own universal functions within its system structure itself, so that there is no need to swing from joy to sorrow by fluctuations in the value of stocks in the stock market, resulting in stable and unfailing asset management.

Both the credit contraction of banks in the above New Deal business slump of 1930s and banks' reluctance to lend in present Japan originate from an exclusive possession of banks on funds loans. Business recovery cannot be attained without overcoming the exclusive possession of banks on funds loans. The present U.S. economic prosperity is derived from rebuilding the nation's economy from 1980s at which the financial deregulation of 1980s breaks down the financial capital market monopoly by the banks; it means that the ways of fund supply and the funds intermediary agents become diversified. It is conceivable that the financial system reform of Reganomics is not only performed as that of bank itself but also performed as a distribution revolution of financial capitals whose financing was mainly conducted by the banks that firmly maintain a monopoly on the monetary market.

On the other hand, the New Deal Government and the relevant authorities criticized and denounced the bank's credit restriction during the New Deal slump. However, the banks' side, the American Bankers Association (ABA) answered that there were no stable borrower. What we learned from this case is that our efforts should be put into the development of a new structured finance, which is a system based on financial technology for supplying risk money with stability, in stead of selectively finding stable borrowers or stable investment targets without risk.

Whatever the case may be, the real business recovery can be accomplished only by nongovernmental economic activities and the capacity to earn profits against investments can be the driving force of economic activities.

Living dead (it is not understood whether it dies or it is living) company is that of fixed sales and business results having no chance to go public on the over-the-counter market. The appearance of living dead companies is a fundamental problem to be caused by the present investment system based on the current stock standard system where there is a small chance to grow going public on over-the-counter. By the numerical statement of the United States, the number of over-the-counter trading companies for National Association of Securities Dealers Automated Quotation (NASDAQ) composite is only 0.8 among 1000 companies that have been in business. As for the investment issue, though it is carefully selected with the invested institutions, the proportion of the number of “living-dead” companies still accounts 80-90% of all the investments. Nevertheless, there is no mechanism itself that collects cash flow earnings from those companies.

About this, certain venture capital (VC) executives expresses his opinion as follows. “We could get over bankrupt companies. Regarding living-dead companies, however, they continue their businesses, so that only much times of managing the companies are taken and there is no reward of the cash flow”. Though the following problems consist in the investment method of the present system, it is not even recognized that such problems depend on the fundamental defects of the present system.

(1) Uncollectable debts of the banks are the by-products of the bubble economy. However, the VC of the U.S. model is the structure itself that generates “living-dead”, resulting in non-collectable loans.

(2) Therefore, though the investments to new companies are aggressively performed and an investment boom happens, such a boom will be also finished as a transient one as the uncollectable debts are piled up.

(3) If the ratio of the number of bankruptcies and living-dead companies to the total number of entire companies becomes high, the selection of investment targets must be inevitably made severe. The investments in the initial stages become difficult furthermore and also in the end the entrepreneur rearing come to nothing.

(4) Both the corporate life and the goods cycle are also shorten by the change in an industrial structure. Therefore, there are sharply increasing cases in which the companies are forced to close or become “living-dead” companies, as they cannot develop and bring subsequent hot-selling products even though the first hot-selling products were brought to market. The current VC investment method of the U.S. model aiming only at the conventional going public over-the-counter has become fall behind the time.

Conversely, the first reason that the VC system of the U.S. model has achieved the outstanding results in the United states is that the United States has the existence of individual investors named as “Angels” and a long history of such an existence. There are natural features among Americans of respecting an entrepreneur under the traditional soul of frontier spirit in the United States. The second reason is that the investment targets are narrowed down to high-tech industries, such as those of IT (Information Technology)-related. The third reason is that necessary terms up to going public over-the-counter market are much shorter. The fourth reason is that the amounts of capital gains when going public over-the-counter are enormous because of the large sizes in their lands, populations, markets, and so on. Basically, these variations depend on the difference among investment conditions in various countries. Therefore, the venture capital market with the high-risk and high-return in the United States has been realized under such a wide choice of favorable investment environments. However, any of different investment environments, investment sizes is unique and hard-to-duplicate feature. Therefore, here in Japan, a new asset investment procedure, which is clearly different from that of U.S. may be the most important not only for rearing entrepreneurs, but also for the rearing of general individual investor. Fundamentally, indirect finances do not get fitted to the raising of funds for in-viable fledgling venture business companies. In addition, in case of venture companies or manufacturing companies that focus on research and development, and therefore require funds and take long time for research and development efforts, business entity powers are exhausted to the raising of funds and anticipatory investments for the technological developments, so that their financial conditions in terms of their balance sheets get worse naturally. For this reason, they cannot make their financial conditions look good to the demands of information disclosure. Consequently in the examination of financial statements, a venture business company that can even be expected to have a bright business future are often considered as investment disqualification, resulting in hard to find stock acceptors.

In general, the entrepreneurs have the difficulties in obtaining initial financings for researches, developments, and industrialization, and the results of the initial endeavours for the technical development can be produced in the forms of patent, business know-how, and so on. In spite of these facts, however, the research and development costs on balance sheet can be only regarded as debt, which is an adverse element of company evaluation. Therefore, especially in Japan, it is difficult to produce an accomplished entrepreneur because efforts of basic research and efforts of research and development are not evaluated in the country.

Considering about the enhancement of the real economy, it is necessary to stand on the starting point of the principle/origin of capitalism once again. On the problem of economic structure, creativity is not born in ignorance of the basic principle. On the basis of capitalistic economy in which speculations are materialized by means of investments and productions, the counter value of investment is a dividend distribution in principle. Thus, if the stocks of venture business cannot produce dividends, such stocks cannot be the targets of investment, and the principle of capital investment (capital and profit) does not work on the case of such venture business. Regardless of such fact, the investment is still performed because the speculative profit (capital gain) takes precedence far more over the investment return (dividend distribution). Therefore, there is a strong necessity to provide a novel structure based on a new concept that complements the detects of the current system for unlisted stock by correcting distortions of the venture capitalism of the rights and wrongs, which are appearing more apparent in the progress toward a knowledge based society.

For complementing a self-defeating contradiction of capital market having indiscriminate investments and speculations, it is considered that the consolidation (consolidated investment beneficiary right) of investment (royalty beneficiary right) and speculation (beneficiary right for sales of stocks) may be very effective. This creates the third fountainhead substantially in the financial capital market for venture businesses, which is now limited only to the two fountainheads; investment profit (dividend distribution) and speculative profit (capital gain). In this case, the new structure allows for the creation of new distribution principle. This third fountainhead, royalty beneficiary right is taken in addition to the cash dividend which is the last profits of production and sale, and therefore even if a company has a deficit, it can converts the royalties (regarded as product costs) added up in proportion to the sales volume into dividend distributions.

More than 190 nations of the world and no less than 5.6 billions people exceeding 90% of world population of 6 billion is leading their lives under the economic system of capitalism. The economic system in the world is functioning under the practice of stockholder in the stock standard system. In such a system, the consolidation of investments and speculations by non-governmental initiatives complements the defects of stock standard system produced by the changes of industrial structure. The consolidation system has a big possibility of potentially having a big influence on the financial capital market in the world.

Then, it is more rational to carry out effective practical use by the consolidation of two financial properties rather than dealing with technology and fund separately. Although it is needles to say, the demand for fund and technical development for venture businesses will repeat its metabolism forever as long as capitalism continues.

However, it is difficult to perform direct investments by means of individual financial assets. It is necessary to direct at least part of risk-averse individual financial assets to investments. For that purpose, in an investment company, a financial product (investment beneficiary certificate) is planned and developed based on the above-mentioned consolidated investment beneficiary rights by which the risk hedge is carried out, and then it is sold on the Internet. Therefore, it is very important to recognize that the certificate sold on the Internet is characterized as an indirect investment but not an indirect financing or a direct investments. It is very important because of the followings; That is, the network securities market on the Internet combines and acts as an intermediary between entrepreneur's demand for fund and individual investor's demand for asset management. The network securities market then enables wholesome asset management (fixed earnings yield) by people to be realized. Simultaneously, in stead of the conventional stock market for unlisted stock (before going public on the over-the-counter market), the network securities market may act as a securities market for incubating the entrepreneurs to be reared, so that it contributes to create venture business and job opportunity and also contribute to rebuild the nation's economy.

The object of the present invention is concerned with the basis of financial economy. Therefore, the origin of capitalism will be mentioned as follows. In addition, we have to discuss standard concepts of what capitalism should be. Looking upon the history of capitalism, the capital suppliers have been changed in response to a change of industrial structure, so that capitalism is doomed to change for it. That is, in the past, when the war industry was needed, national monopolistic capitalism gained power. On the other hand, currently, speculation capitals overwhelm the financial capital markets in the world by means of information technology innovation that put electronic technology to full use. Accordingly, the features of capitalism depend on the capital suppliers, putting aside the morality thereof.

By considering with any method such as an elimination, the way of the national capitalism in which sovereignty resides with the people is only left for the 2first century capitalism. In addition, it is in the upheaval time of the industrial restructure by IT revolution now. Therefore, it has been demanded to reform a financial system by means of the indirect investment that put IT technologies and networks to full use. By such reform of the financial system, at least part of people's property can be utilized for an economic activity, so that it will help the structural reorganization.

### SUMMARY OF THE INVENTION

An object of the invention is to provide a method of investment management in which individual asset managements (indirect investments) are practical and feasible in stead of the so-called U.S. angels (direct investments). This management method is derived by learning a lot from the opposite economic phenomena (namely, the New Deal depression and Reagnomics) of the present and the past in the U.S. history, respectively, and also from the U.S. government's financial economic policies for solving the conventional problems on the basis of the underlying essence of things in the depression and the understanding of the present economic and financial conditions.

In the first aspect of the present invention, a method of investment management for managing an investment to a business to be performed by an entrepreneur using an intellectual property right, comprises the steps of: storing information about a beneficiary right in a first server computer, wherein the beneficiary right is based on the intellectual property right transferred from the entrepreneur to a fund donor in exchange for funds to be provided to the business and supplied by the fund donor; and performing an income estimation about the investment to the entrepreneur at the first server computer on the basis of the information about the beneficiary right stored in the first server computer and information about proceeds of the business of the entrepreneur received from a fist client computer.

Here, the beneficiary right may include a right to receive a royalty from the entrepreneur under a license being granted to the entrepreneur on the basis of the intellectual property right being transferred to the fund donor.

The method of investment management may further comprise the step of: notifying to the first client computer that processes the information about the entrepreneur before the intellectual property right is transferred from the entrepreneur to the fund donor, wherein the notifying step including the steps of: the first server computer receives an application for financing to the business of the entrepreneur from the first client computer, and the first server computer transmits notice information chosen from two or more notice information for notifying a corresponding examination result about the application to the first client computer, wherein the two or more notice information for notifying the respective examination results is previously stored in the first server computer.

The information about the proceeds of business may include information about an income to be brought from the entrepreneur.

The step of performing the income estimation may include the step of calculating an estimated amount of the income to be brought from the entrepreneur.

The intellectual property right transferred from the entrepreneur to the fund donor may be a target property of trust with the fund donor.

The first server computer may take charge of an income obtained by means of the beneficiary right as reinvestment capital funds for another business to circulate the income.

The information about the beneficiary right may include information about a fund that is established by the fund donor with respect to the beneficiary right on the basis of the intellectual property right transferred from the entrepreneur to the fund donor.

The method of investment management may further comprise the steps of: storing sales information about a financial product in a second server computer that processes information about a financial institution that supplies the financial product that is made from the beneficiary right transferred from the fund donor by means of processes of liquidating and securitizing an asset; and transmitting the sales information stored in the second server computer to a second client computer that processes information about an investor.

The method of investment management may further comprise the steps of: receiving information on purchase application from the second client computer by the second server computer, wherein the purchase application is provided for the purchase of a financial product represented by the sales information transmitted from the second client computer to the second server computer; and transmitting reply that corresponds to the purchase application provided for the purchase of the financial product from the second server computer to the second client computer, wherein the reply is chosen from a plurality of reply information by the financial institute, wherein the plurality of reply information is previously stored in the second server computer for the purchase application.

The beneficiary right transferred from the fund donor may be a priority beneficiary right.

The financial product may be a fixed interest security.

The beneficiary right transferred from the fund donor may be a investment target priority for a pension fund management by the financial institution.

The beneficiary right may be consolidated investment beneficiary right that further includes a beneficiary right on the basis of securities with stock instrument included issued by the entrepreneur.

In the second aspect of the present invention, an investment management server for managing an investment to a business performed by an entrepreneur using an intellectual property right, comprises: a storage means for storing information about a beneficiary right based on the intellectual property right transferred from the entrepreneur to a fund donor and supplied by the fund donor in exchange for funds to be provided to the business; and a calculation means for performing an income estimation about the investment to the entrepreneur on the basis of the information about the beneficiary right stored in the storage means and the information about sales proceeds of the business received from a fist client computer that processes information about the entrepreneur.

The beneficiary right may be consolidated investment beneficiary right that further includes a beneficiary right on the basis of securities with stock instrument included issued by the entrepreneur.

In the third aspect of the present invention, a financial transaction server that performs a processing about a financial institution that supplies a financial product based on a beneficiary right transferred from a fund donor, comprises: a storage means for storing sales information about the financial product; and a transmitting means for transmitting the sales information stored in the storage means to a second client computer that processes information about an investor.

Here, the beneficiary right may be consolidated investment beneficiary right that further includes a beneficiary right on the basis of securities with stock instrument included issued by the entrepreneur.

In the fourth aspect of the present invention, an investment management system for managing an investment to a business performed by an entrepreneur using an intellectual property right, comprising: the investment management server in the second aspect of the present invention; and the financial transaction server in the third aspect of the present invention.

In the fifth aspect of the present invention, a computer-readable medium capable of configuring a first server computer that manages an investment to a business to be performed by an entrepreneur using an intellectual property right to perform a method of investment management, the method comprises the steps of: storing information about a beneficiary right in the first server computer, wherein the beneficiary right is based on the intellectual property right transferred from the entrepreneur to a fund donor in exchange for funds to be provided to the business and supplied by the fund donor; and performing an income estimation about the investment to the entrepreneur at the server computer on the basis of the information about the beneficiary right stored in the first server computer and information about proceeds of the business of the entrepreneur received from a fist client computer.

Here, the beneficiary right may be consolidated investment beneficiary right that further includes a beneficiary right on the basis of securities with stock instrument included issued by the entrepreneur.

In the sixth aspect of the present invention, a computer-readable medium capable of configuring a second server computer that performs a processing about a financial institution that supplies a financial product based on a beneficiary right transferred from the fund donor in accordance with claim 18 or claim 19 to perform a method of investment management, the method comprises the steps of: storing sales information about a financial product in the second server computer; and transmitting the sales information stored in the second server computer to a second client computer that processes information about an investor.

Here, the beneficiary right may be consolidated investment beneficiary right that further includes a beneficiary right on the basis of securities with stock instrument included issued by the entrepreneur.

Accordingly, the configuration of the present invention will be outlined as follows.

Intellectual-property-rights trust whose fund donor takes over trust instead of patent-right trust as a target property of trust of the business know-how belonging to small and medium-sized enterprises or the like.

Computer system, where a fund donor's computer and an entrepreneur's computer are connected through a communication means, and the sales information entered in an entrepreneur's sales information database is automatically entered into a fund donor's server computer and also automatically outputted from this computer.

The computer system by which input/output of the sales information as which it connected through the communication means and a fund donor's computer and an entrepreneur's computer were inputted into an entrepreneur's sales information database is automatically carried out to a fund donor's server computer.

Income-and-expenditure calculation and risk management, which are performed in block by a fund donor, which respect to the money payment contract concluded among two or more entrepreneurs.

Computer system that plans, develops, and sells a financial product (investment beneficiary certificate) on the bases of the consolidated investment beneficiary right transferred from a fund donor, using the security purchase application form obtainable in the homepage for distribution to investors.

Risk hedge of investment, which is allowed by profit strengthening by combined factors that include the liquidation of capital and asset, and the increase in efficiency of the investments and reinvestment.

Trust complement and setup of priority and subordination structure. That is, earning-capacity is strengthened by the liquidation of capital and property and the reinvestment by the use of profit surplus internally retained, and a trust complement of the investment beneficiary certificate (fixed yield) that tries investor protection is performed, and further the priority and subordination structure are set up. The term “priority beneficiary right” stands for a trust complement of an investment beneficiary right, where the profits attribution to an investor is performed with priority when a return on investment does not reach the amount of anticipation.

Common trust. That is, coexistence of 401K pension annuity management and the demand-for-fund needs of a venture business is allowed. Simultaneously, the trust and banking company, i.e., a common fund donor, performs administration of the trusted property by a computer system.

Recruiting investors as fund donors and constructing the fund with some amount of money. The above consolidated investment beneficiary right is distributed in proportion to each investor's investment ratio, and a royalty income is paid for every half a year or every year.

Business for collecting non-collected loyalties or the like, which is commissioned to a servicer (debt-collection firm).

Make the venture support network using IT for rearing a venture business.

Furthermore, the following actions are produced by such composition.

Practical use of the consolidated assets that include investment capitals, stocks, and intellectual property rights.

Creation of the consolidated investment beneficiary right by concluding a trust contract, a financial contribution contract, and a license contract between an entrepreneur and a funds provider (fund donor) as the parties concerned.

Liquidation (or securitization) of funds and assets that comprise the above-mentioned consolidated investment beneficiary right, investment beneficiary securities, and raising of reinvestment capital funds.

Formation of investment and reinvestment cycles made up of a venture company (entrepreneur), an investment company (funds provider), a financial institution, and a security buyer.

In this invention, “the patent right with a business plan or scheme” is the target property of trust for an investment company to accept the trust (entrust). Therefore, debts (research and development costs), intangible fixed assets (patent right), and intellectual property rights such as business know-how can be converted into liquidated assets. The venture business can utilize two hidden assets: intellectual property rights such as patent right and know-hows in business; and stocks for raising industrialization funds.

Furthermore, in this invention, unless financial condition is very bad, a royalty income is obtained in proportion to sales. Therefore, independently of the conventional affairs or the conventional goods, the financial funds can be specifically provided for the growth possibilities of specific new technology, and specific new goods, or specific new service. Consequently, the venture business can be evaluated by its technologies or new goods rather than stocks and the patent right itself, so that a present value method in which future benefits (values) are converted into present benefits (values).

Originally, trust was the private sector trust based on the confidential relationship between individuals. In Britain of the Middle Ages, it was the system which progressed in the diplomacy with the man of power at the time as confrontation means, against the land confiscating law. Accordingly, taking the history of trust, present-day deregulation, and development into the knowledge-based society into consideration, the intellectual-property-rights trust that makes business know-how the object property of trust can be included in this invention.

The industrialized business know-how has an intellectual value, which is equal to or more than that of “patent right with business plan.” Since the law relation of trust is a private law relation on the principle of contract freedom, the intellectual-property-rights trust is subject to private sector trust and materialized by agreement of the both sides of an entrepreneur and a fund donor. Therefore, this invention is not limited only to patent-right trust. In other words, the investments can be provided to more wide range of targets by the development of intellectual-property-rights trust, which exchanges a know-how concession contract instead of a license contract, just as in the case with the patent trust.

In the present invention, the conversion function of the following patent-right trust is utilized at maximum as means to solve the problems.

The function that converts time.

The term of trust can be arbitrarily set by persons concerned. In patent-right trust, the continuation term (20 years after application for patent) of patent right is a trust term (“disposal type trust”). Alternatively, it limits to an establishment period (“managed type trust”). In this invention, by the way, the latter “managed type trust” is adopted. That is, when the amount of money of the royalty paid to an investment company from a venture business reaches the predetermined amount, the trust term is terminated and the right returns to the venture business.

The function that converts the quality and character of property.

A fiduciary contract (the name of patent right is transferred to a fund donor) is concluded between a venture business (entrepreneur) and an investment company (fund donor) as the parties concerned. Then, the patent-right trust is set up and the beneficiary right is transferred. In this case, the patent right on its appearance is still possession of the fund donor. However, the substantial right is embedded and embodied in the beneficiary right (royalty), and transferred and circulated.

Conversion to a consolidated investment beneficiary right (property to be made for liquidation or securitization).

In addition to the intellectual-property-rights trust, separately, the stocks of a venture business are acquired (equity instrument) and future profits by holding stock (capital gain) are also provided as beneficiary rights. This is consolidated with the above-mentioned royalty beneficiary right (right of the benefit which receives a royalty profit). Thus, the royalty in this invention does not remain a mere royalty income. Two beneficiary rights with different characters are consolidated, and an investment scheme is built based on the use of the conversion function peculiar to trust mentioned above with liquidation of the property utilized as a “consolidated investment beneficiary right.”

The function that converts the number of rights.

A trust has a function of changing the number of rights from plural to singular number, and vice versa. That is, the consolidated investment beneficiary right based on two or more fiduciary contracts and investment contracts with a venture business is pooled, and a set of these contracts is transferred to a financial institution, so that the number of consolidated beneficiary right is changed from plural to singular number. Furthermore, the financial institution designs and develops a financial product “an investment beneficiary certificate”, so that the number of consolidated beneficiary rights is again converted into plural from singular number by selling such certificates to many investors.

The present invention provides the present risk capital system with a patent right, where the former is limited to the negotiated transaction between an investment and stocks and the latter corresponds to a liquidated asset in the method of liquidating an asset. A property conversion function peculiar to the property liquidation and trust is used for the consolidation of investment and speculation by the above-mentioned capital investment principle. An investment scheme is built on the basis of the following principles.

If a right is replaced with another property right of different features, the utilization objective may be also changed. Specifically, the notional property of intellectual property rights is changed to industrialization capital funds. Two hidden assets, intellectual property rights (e.g., patent right or business know-how, which belongs to the venture business) and stocks, are converted into two beneficiary rights having different features. They are consolidated together and made liquidated asssets. Subsequently, they are changed to an investment beneficiary certificate and consequently, an investment cycle is formed by the business method for selling the investment beneficiary certificate.

Raising funds for a reinvestment by means of the enlargement of the target assets for liquidation means the shortening of the above mentioned term of equity instrument. Therefore, the problem (i.e., the problem of non-liquidated assets and inefficiency of investment capital management) is solved by the present invention. Furthermore, if the cash flow that corresponds to a dividend or interest could be obtained in spite of the long term required to go public on the over-the-counter market, the problem of inefficient capital management in the venture business investment may be complemented.

A consolidation system of investment and speculation will be able to supplement the defects of the current venture capital market, and it will be definitely realized. It is considered that the venture capitalism should sustain various types of venture capitalism depending on the circumstances in respective countries in addition to that of the United States. Presently, in Japan, restructure of the economy has been required. An economic activity should be promoted by creating a new financing method as an economy-boosting measure is to be generated from the source of the capitalistic economy system itself, rather than issuing deficit government bonds. It can be said that there are no other business stimulative measures which surpass this.

The equity investment term is set by the current law with respect to an investment enterprise association. Turning over the fund investment 2 to 5 times allows the increase in benefit 2 to 5 folds during 10 or 12 years of such a term. In this case, only the number of target companies for investment and the amount of investment are accumulatively increased, while the investment principal risk is infinitely decreased. The recession factors in Japan now, include that the capital becomes non-performing loan and the property turns into a non-liquid asset. On the other hand, earning capacity is strengthened with making the structure in which the capital can be turned over. As a result, the investment risk of venture business itself is mitigated by the profit surplus. In this case, the investment risk is reduced, of the new financial product to be sold to an investor.

The venture business investment is the pronoun of a high risk because of the investment form of the present stock-based system in which cash flow return is realized only at the time of going public. As a matter of fact, the target property is an exchange between an investment capital and stocks. In addition, the investment funds are fixed until the time of going public to the over-the-counter (OTC) and the assets are being managed as non-liquid assets. In other words, high risk and high return are exactly the reflective idea, portrayed thereon by the configuration of the current stock system, so that the conventionally established theory and conventional investment concept can be reversed from the bottom by viewing from different perspectives. The relationship between risk and return is not always proportionate to each other and the financial business in IT period is able to create a higher return by creating a new structure that can reduce a risk.

Therefore, it is not dependent on a credit complement by way of collateral or a credit guarantee. By the business method which mitigates a risk within structure itself, venture investment having been considered to be high-risk and high-return is transfigured into a stable-return and low-risk investment. The new financial industry can be created, which has the financial circulation function with the new concept, “indirect investment” of the low risk and middle return which is not either indirect financing (loan) or direct investment (VC) of the present time.

Process and procedure of the present invention will be outlined as follows.

(1) The investment company invests in the venture business group “A” consisting of a plurality of venture companies.

(2) The investment company acquires stocks of the venture business group “A”, and inherits the patent right of the venture company in the venture business group “A” as a trust fund.

Then, the investment company makes a consolidated investment beneficiary right by consolidating together one beneficiary right based on the stock and another beneficiary right based on the patent right.

(3) After the patent right is transferred from the venture business group “A” to the investment company in the trust fund, a grant of license is concluded between the investment company and the venture business group “A”. That is, the license based on the patent right already transferred to the investment company is permitted or lent to the venture business group “A”, so that the venture business group “A” can carry out their own businesses by utilizing the patent right.

(4) The venture business group “A” that has obtained capital funds by means of two latent assets consisting of stocks and patent right, pays a predetermined rate of the royalty in proportion to the proceeds of the goods sale or services offered with respect to the grant of license. The contract for the venture business group “A” to pay such predetermined royalty to the investment company is made.

(5) A consolidated investment beneficiary right (beneficiary right about the total unrealized profits of the estimated amount of royalty and the estimated amount of capital gain) can be pooled by the investment company, and then the packaged transfer of the consolidated investment beneficiary right is carried out by the investment company to the special purpose companies, such as a financial institution. By such packaged transfer of the consolidated investment beneficiary right, the investment company can raise the funds for reinvestment capital.

(6) The investment company can not only raise the funds for reinvestment, but also can raise the earning capability for the reinvested capitals, by the packaged transfer of the consolidated investment beneficiary right.

(7) The financial institution plans and develops an investment beneficiary certificate (a financial product with fixed coupon rate) on the basis of the assigned consolidated investment beneficiary right. The financial institution sells such investment beneficiary certificate to institutional investors and individual investors.

(8) In order to protect the interest of the investors, the investment beneficiary certificate is complemented with trust by setting up a priority beneficiary right and a subordination beneficiary right.

(9) Then, the investment company can use the income resulted by firstly the packaged transfer of the consolidated investment beneficiary right and secondly the sales of the investment beneficiary certificate( a financial product), for investing into venture business group “B”.

The repetition of the above-mentioned process and procedure enables the increase in efficiency of capital investment by capital liquidation and securitization. Moreover, earning capacity rises with above-mentioned process and procedure. The retained earnings to be accumulated by both the increase in efficiency of the capital investment and the rise of the earning capability can be used to supplement the credibility of the investment beneficiary certificate (a financial product).

Therefore, the risk to the initial investment(initial capital injection) is reduced. Moreover, the “law of large numbers” can be occurred accompanied with accumulated investments, simultaneously with the risk hedge of both an investment and a reinvestment. As a result, the investment risk about the venture investment itself also decreases by carrying out indexation of the venture business portfolio.

Furthermore, the promising venture business, which can be expected to grow, can receive secondary and third additional investments. As a result, the possibility for venture business to go public can be raised as the so-called incubation function, such as venture support and a consultant, are strengthened.

(10) This securitization model is designed for capital liquidation or securitization of the initial investment(initial capital injection) to the investment company. Therefore, the fund donors(initial investors) to the investment company can not only gain the dividend and subordination beneficiary right of the investment company perpetually, but also can earn a large amount of the capital gain, when the investment company itself goes public.

(11) This securitization model can also be used to earn the royalty from living-dead companies whose sales and profit are fixed and stagnant without a possibility of their going public.

According to this invention, the following effects can be attained. That is, unless the financial condition of investment target company is very bad, a royalty income is obtained in proportion to sales. Therefore, independently of the conventional business operations, investments can be specifically provided on the growth possibility of specific new technology, specific new goods, or specific new service. On the other hand, the venture business that receives investments utilizes hidden assets, such as patent right or business know-how, and stocks, for raising capital.

In addition, the present value method, replaced for the current value method can estimate the future profit of patent right and business know-how and then turn them into the present value. Therefore, compared with current market evaluation, investment with a comparatively large amount of money is attained. Furthermore, the profit potential of each of business know-how and patent right increases infinitely as the development of business is accelerated. Additional investment accompanied by the expansion of business can also be performed at a smaller risk. Moreover, the entrepreneur's company can raise more fund much easily.

A profit situation can be grasped using a fund donor's database. Therefore, the accuracy of risk management also improves much more.

Since two or more companies are managed collectively, a risk is diverted. Therefore, the uncollectable debts caused by the high rate of bankruptcy and the associated high risk are off-set by the profit from other companies.

Since a royalty income can be expected even if it is the living dead company in which the sales are fixed with no prospect for going public, the way of new capital raising is exploited towards business recovery.

Furthermore, an earning ratio can be adjusted by the adjustment of the profit and loss balance, where the relationship between risk and return is replaced with the income-and-expenditure calculations of total risk (expenditure) and total return (sales), and the adjustments of a rate of royalty and a profit multiple rate of royalty (2 to 4 fold) increase in proportion to the investment amount of money.

Reinvestment capital is raised to be reinvested to one or more new companies, allowing that the earning capacities from the invested companies can be raised. As a result, an investment capital risk is also reduced while the risk of an investment principal is simultaneously reduced. On the other hand, the number of investment target companies is accumulatively diverted and thus the indexed portfolio of the companies can be obtained.

The efficiency of investment is increased by repeating the reinvestment. Consequently, only a profit is multiplied, with an investment risk not changed and the risk hedge of an investment is achieved.

Moreover, only the priority beneficiary right of a consolidated investment beneficiary right is transferred to a special-purpose company (financial institution) from an investment company. A credit complement for the concerned investment beneficiary certificate to be sold to an investor can be achieved. And, consequently, the risk of the security sale can be reduced.

Furthermore, a little influence will be exerted to this system from economic trends or stock market fluctuation, and the profit stabilized in the long run can be attained. Therefore, the business for investment securitization of venture business corresponds to the demand for raising funds for the venture business while it is the most effective investment target for pension fund management. Consequently, it can contribute to create more venture businesses and create more jobs for employment expansion.

Furthermore, establishment of a new company and development of new technology will be repeated forever as long as capitalism continues. Therefore, the investment securitization business that tries to accelerate these two matters, will never go out of use, unless capitalism goes out of use, and the multiple effects of a new financial industry creation for the capitalistic society will be far more than one can imagine.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a block diagram that illustrates an example of network system on which the present invention is applied;

FIG. 2 is a block diagram that illustrates the configuration of a system that constitutes the network system on which the present invention is applied;

FIG. 3 is a block diagram that illustrates a flow of steps in the method of liquidating and securitizing the assets in accordance with one of preferred embodiments of the present invention;

FIG. 4 is a block diagram that illustrates a communication sequence in accordance with one of preferred embodiments of the present invention;

FIG. 5 is a block diagram that illustrates a communication sequence in accordance with one of preferred embodiments of the present invention; and

FIG. 6 is a block diagram that illustrates a flow of steps in the method of an investment fund trust in accordance with one of preferred embodiments of the present invention.

### DETAILED DESCRIPTION OF PREFERRED EMBODIMENTS

Hereinafter, we will describe a detailed explanation of each preferred embodiment of the present invention with reference to the attached drawings.

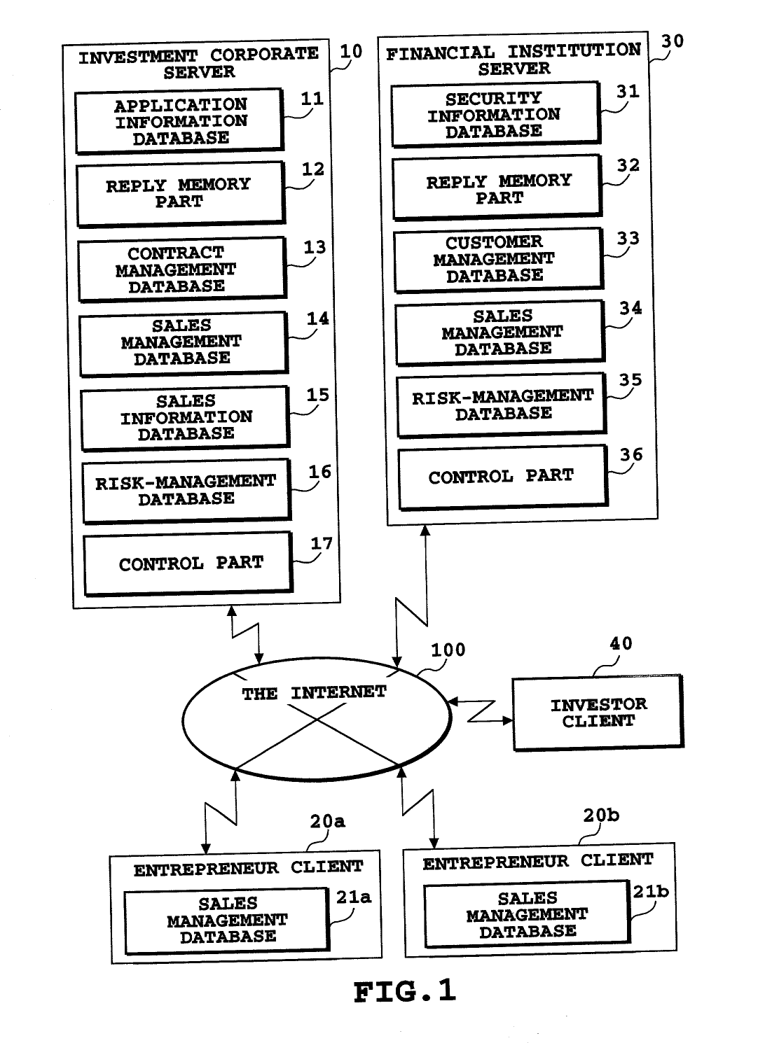

FIG. 1 is a block diagram that illustrates a configuration of network system to which the present invention is applied. For clarity, in the figure, components that concern the present invention are only represented. The system comprises an investment corporate server 10, a financial institution server 30, two entrepreneur clients 20a and 20b (hereinafter, also referred to as the entrepreneur client 20), and an investor client 40. The investment corporate server 10 functions as a Web server installed in the investing company that is a fund donor. The financial institution server 30 functions as a Web server installed in the specific company (namely, financial institution) that performs security sale.

The entrepreneur client 20 is installed by each entrepreneur who turns into that of venture business or the like. The inventor client 40 is used when the customer of financial institution makes an investment. Furthermore, each equipment is mutually connected through the Internet 100 used as an example of a communication network. The investment corporate server 10 is a server computer that performs processing about trust through the Internet 100. The investment corporate server 10 comprises an application information database 11, a reply memory part 12, a contract management database 13, a sales management database 14, a sales information database 15, a risk-management database 16, and a control part 17. The application information database 11 is a set of the application information for financing to be received from the entrepreneur. This application information is one transmitted from the entrepreneur client 20. As for this information, a business person enters the predetermined items into the predetermined application form. The application form may be in the form of a Web page offered by the investment corporate server 10. Items to be entered in the application form may include: the outline of the patent right which the entrepreneur owns; category of business; the outlines of both an industrialization plan and a plan to commercialize; the desired amount of necessity money and the outline of a capital plan; and an applicant's name, address, age, and so on. By the way, the funding application is not only performed by the entrepreneur but an intermediary, such as of intellectual-property-rights dealings business, as a representative using the terminal of exclusive use.

The reply memory part 12 stores the contents of the reply from the fund donor to an application of the above-mentioned financing after matching them with the information about the entrepreneur. The fund donor examines an investment issue based on each of the application information stored in the application information database 11. Next, the examination result is notified using the investment corporate server 10. In this case, two or more contents of reply for notifying adoption, a rejection, etc. beforehand are prepared in the investment corporate server 10. Therefore, the fund donor chooses the items corresponding to the entrepreneur's examination result from these contents of a reply. The selected contents of reply are transmitted to the entrepreneur client 20 and stored in the reply memory part 12.

The contract management database 13 stores both the contents of financial contribution contract and the contents of the fiduciary trust contract concluded between the entrepreneur and the fund donor about the investment issue accepted to be an investment object as a result of examination. Similarly, the contract management database 13 stores the contents of enforcement contract in which the given rate of royalty should be paid on the basis of the sales proceeds of goods or offer of services using patent right. The contents of trust agreement includes the conditions in which the name of patent right is transferred to the name of the investment company as the fund donor, and the conditions that terminate the trust here for the purpose of financing.

The financial contribution contract is a between-persons-concerned contract of a purport that the fund donor acquires the entrepreneur's stocks. Furthermore, an enforcement contract is based on the patent right transferred to the fund donor's name, and permits or sets the right to be licensed back to the entrepreneur. Moreover, the enforcement contract includes the contents which the given rate of royalty should be paid in proportion to the amount of sales in business carried out in accordance with the enforcement contract by the entrepreneur.

The essentials of the above-mentioned contract (namely, fiduciary trust contract) inputted into the contract management database 13 are as follows:

agreement to information disclosure of entrepreneur's financial condition etc.;

agreement of transferring the patent right which the entrepreneur owns as fiduciary asset to the fund donor:

agreement of providing an entrepreneur with the amount of money as a purpose of trust which has been agreed with the entrepreneur; and

agreement of returning the patent right which was transferred from the fund donor back to the entrepreneur when the fiduciary trust contract ends as the accumulated payment of the royalty to the fund donor reaches the amount of money which had been agreed beforehand.

Moreover, an equity instrument includes the following items:

agreement on which the fund donor acquires the stocks which the entrepreneur issued; and

agreement on which the fund donor sells the consolidated investment beneficiary right to a third person, where the consolidated investment beneficiary right is based on the stock sale income and the income by the royalty from the entrepreneurs.

An enforcement contract includes the following items:

agreement on which the fund donor permits or grants the license to the entrepreneur, where the license is of the patent right transferred to the fund donor; and

agreement on which the entrepreneur pays the rate of royalty which has been agreed to the fund donor in proportion to the amount of proceeds by the sale of goods or offer of services using the concerned patent right.

The sales management database 14 stores the information on the sales management database 21a or 21b (hereinafter, also referred to as the sales management database 21) transmitted from the entrepreneur clients 20a or 20b, respectively. In other words, the sales management database 14 stores the royalty income (expected amount of money received/monthly basis) that uses the daily sales in the entrepreneur (venture business) as a base. In a venture business, appropriation of the royalty is processed as product cost from the time of a contract. Therefore, if sales are increased as originally planned, cash flow will be in a upward trend.

The sales information database 15 stores the data about the profit and loss of investment calculated based on the data stored in the sales management database 14. The data about profit and loss includes the so-called sales forecast information. Specifically, the data about profit and loss includes the following items: title of a trust issue; name of a venture business; the term of validity of the patent right concerning trust; the amount of investment concerning trust; the amount of investment in the case of acquiring the entrepreneur's stocks; the amount of accumulated royalties to be used as the conditions of trust expiration; rate of royalty; the amount of proceeds for every (for example, half a year) calculation period about the goods sale or service offer of the entrepreneur using the grant of license; the status of the receipt of the royalty; the amount of royalty for every calculation period; the expected time of a venture business' going public; an expected stock price when a venture business goes public; and the payment of the dividend to the stockholders after going public. The data stored in this database can be used in the following exemplified procedures.

Grasp of an expiration of trust.

“The actually accumulated amounts of royalties for every calculation period” is always compared with “the total amounts of royalties referred to as the conditions of a trust end.” An expiration of trust is judged based on the comparison result. Moreover, the expiring time of the trust is predicted from “goods sale that are produced by the entrepreneur's enterprise” or “trend of the sales proceeds of service offer.”

Risk-management processing.

When the entrepreneur's stocks are being listed, “forecast of the sales proceeds of the goods that are produced by the entrepreneur's enterprise” and “fluctuations in the value of stocks” are considered. Terminating the trust by selling a stock for profit allows the reduction in risk of investment, even if an accumulated amounts of royalties do not fulfill the expiration conditions of trust, when the reduction of sales proceeds and the fall of a stock price are expected from now on.

In the case of venture business, it generally takes years for the sales to go up. Moreover, the information stored in the database is only an unstable element, “estimated sales information.” Therefore, it is always necessary to grasp an investment situation. The rates of bankruptcy in each industry are expected from the beginning based on the industry data. Therefore, the sales estimation information to be introduced into the sales information database 15 is used as the basic data of risk management.

The risk-management storage database 16 is obtained on the basis of data stored in the sales information database 15. The database 16 stores data concerned about the loss by the entrepreneur's bankruptcy, the amount of royalty expected from sales before the bankruptcy, and the amount of total assets of the living-dead company that has no possibility of going public.

The control part 17 performs receipts and payments calculations on the amounts of actual sales proceeds, the amounts of estimated sales proceeds, and investments to each enterprise on the basis of the data stored in the contract management database 13 and the sales management database 14. Grasp of the trust expiration mentioned above and the procedure for the trust expiration are performed by the control part 17. Moreover, another procedure is performed for storing the results of such calculation in the sales information database 15 or the risk-management database 16.

The entrepreneur client 20 has the sales management database 21. This database 21 manages the sales of the enterprise based on the rights being received as licenses from the respective fund donors. Moreover, this database 21 is comprised of the enterprise sales data inputted by the operator of each venture business. The data on the sales management database 21 is automatically transmitted to the investment corporate server 10 at every fixed interval. By this way, while the time for the data inputting in an investment company can be saved, grasp of an exact sales situation is attained.

Furthermore, the financial institution server 30 is a server computer for transactions. This computer is used in order that the financial institution may conduct selling of financial products, and so on, where the financial institution is given the above-mentioned consolidated investment beneficiary rights from an investment company. This server 30 receives the information about each item stored in the contract management database 13, the sales management database 14, the sales information database 15 and the risk-management database 16 of the investment corporate server 10, and the sales management database 21 of a venture business through the Internet 100. The server 30 registers the received information into a database, or performs the procedures of risk-management using this information. The financial institution server 30 comprises a security information database 31, a reply memory part 32, a customer management database 33 that stores the customer information containing a list of customers with their names, a sales management database 34 that stores the proceeds of security sale, a risk-management database 35, and a control part 36 at least.

The security information database 31 stores the Web page. The Web page provides the security sales-related information to be displayed for the investor client 40. The Web page may include the kinds of the financial products and the product purchase application form with respect to the sale of an investment beneficiary certificate, which is planed and developed on the basis of the above-mentioned consolidated investment beneficiary right. In this case, it is to be understood that the contents of Web page are not limited to any particular items. Therefore, the investors can access to the financial institution server 30 using their own client 40, respectively and examine financial product information through the Internet 100. Each of the inventors can apply for a desired security and performs a purchase application using the form.

The reply to the inquiry to the financial institution server 30 being received from the investor client 40, in correspondence to the information about such an investor, is subsequently stored in the reply storage part 32.

The customer management database 33 is a set of the data that consists of the information about the customers of a financial institution. The data stored in the sales management database 34 is the same as that of the sales management database 14 transmitted from the investment corporate server 10. Furthermore, the risk-management database 35 stores the data of the amount of estimated unrealized capital gains of a living dead company without possibility of going public and the amount of royalty proceeds by the time of the entrepreneur's bankruptcy or the expected loss due to the bankruptcy. That is, the control part 36 of the financial institution server 30 verifies doubly the contents of the entrepreneur's profit-and-loss on the basis of the information received from the investment corporate server 10. Subsequently, the control part 35 analyzes the future amount of unrealized capital gains and royalty, on the basis of the industry data in which the situation of the industry and the input data are utilized. Then, the control part 35 calculates the profit—and—loss account which is being accumulated as time goes by. The calculated result is then stored in the risk-management database 35.

The investor client 40 is a client computer that performs the processing about the investor who is a beneficiary. Here, the beneficiary means an equity participant of the fund capital (investment principal) that an investment company or the like invites. When the capital or debt of the investment company are turned into investment principal (investment capital to a venture business), a beneficiary's status is converted into a stockholder's status.

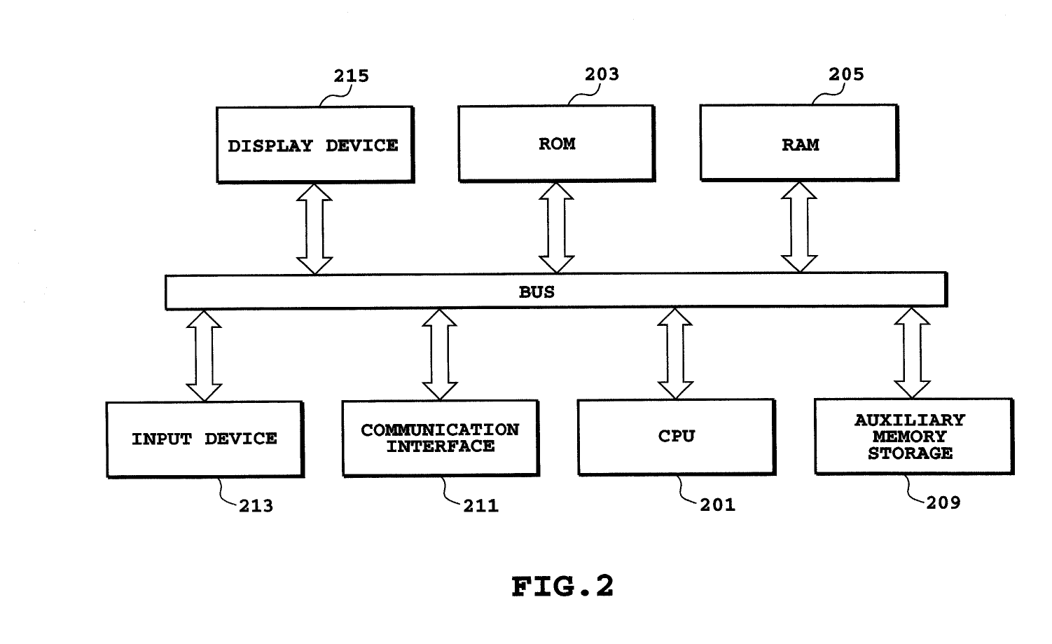

FIG. 2 shows the hardware composition of a computer system used as server and client of the above-mentioned network system. The computer system comprises a central processing unit (CPU) 201 and a random access memory (RAM) 205. These components are connected with an auxiliary memory storage 209 and a read only memory (ROM) 203 through a bus 207. The auxiliary memory storage 209 may be a hard disk drive, a CD-ROM drive, a digital video disk (DVD) drive, or the like.

The auxiliary memory storage 209 and ROM 203 store the programs for executing the process related to the present invention and the data to be referenced by such programs.

A communication interface 211 can use a modem connected with the bus 207. The modem may be of enabling data-communications connection to the Internet 101.

A display device 215 may be used, including a liquid crystal display (LCD), a cathode-ray tube (CRT), or the like. An input device 213 may be used in order to input characters and numbers, including a keyboard, a mouse, or the like. These components may be also connected together through the bus 207.

Many functions of this invention are attained when the CPU 201 executes the commands based on a program. This program is obtained as one loaded from each of ROM 203 and the auxiliary memory storage 209 of each device that constitutes the network system.

Next, we will describe the method of investment securitization using the network system constituted as described above.

[First Preferred Embodiment]

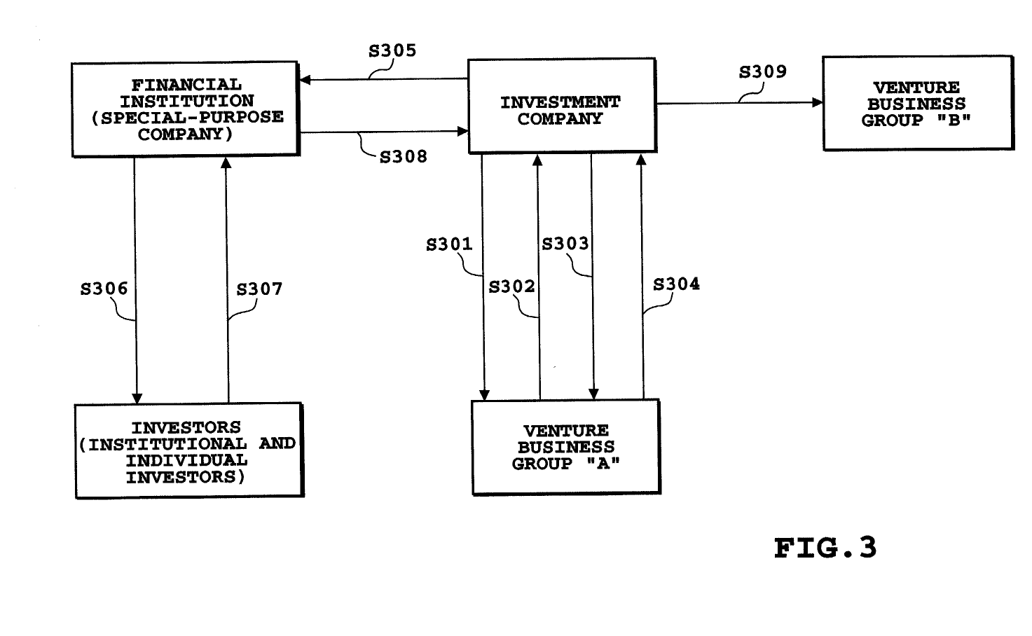

FIG. 3 is a block diagram that illustrates the procedure of an investment securitization business using the network system shown in FIG. 1 in which the present invention is implemented. First, the entrepreneur client 20a of venture business group “A” accesses the Web page of an investment corporate server 10 through the Internet 100. Next, a specified application form for financing, which has been prepared in advance in such a Web page is downloaded. The entrepreneur enters required matters in the application form downloaded into the entrepreneur client 20a. That is, the information on an investment issue is filled up in the form. In this case, the investment issue contains the business plan of the enterprise that uses the patent right belonging to the entrepreneur. The application form is then transmitted to the investment corporate server 10. In the investment corporate server 10, the information for application received from the entrepreneur client “a” is stored in the application information database 11.

Next, the investment company examines the entrepreneur's application information stored in the application information database 11 on the basis of a predetermined examination standard. In this case, the interview with the entrepreneur may be performed if needed. Then, the investment company determines if or not it can finance to the investment issue selected as an investment target.

Subsequently, a reply format is selected from those stored in the investment corporate server 10, and the reply is notified to the entrepreneur client 20a. When the investment company determines the investment to venture business group “A”, here, the conditions for concluding the fiduciary trust contract and equity instrument with the entrepreneur are transmitted.

Subsequently, for the venture business and the investment company as the parties concerned, the following two contracts are concluded, i.e., “the fiduciary trust contract (managed type trust) of patent right” and “the equity instrument with a purport that the fund donor acquires the stocks of the venture business.”

After the above steps, the contents of each contract are transmitted for confirmation from the investment corporate server 10 to the entrepreneur client 20a, and the venture business group “A” consisting of a plurality of venture companies receives the investments (S301).

The investment company acquires stocks of the venture business group “A”, and inherits the patent right of the venture company in the venture business group “A” as a trust fund (S302). Then, the investment company makes a consolidated investment beneficiary right by consolidating together one beneficiary right based on the stocks and another beneficiary right based on the patent right. Subsequently, a grant of license is concluded between the investment company and the venture business group “A”. The contents of the contract are as follows. That is, the license based on the patent right transferred to the investment company is permitted or lent to the venture business group “A”, and also the venture business group “A” pays a predetermined rate of the royalty in proportion to the proceeds of the goods sale or services offered with respect to the grant of license. These contents of the contract are also transmitted to entrepreneur client 20a from the investment corporate server 10 (S303).

The venture business group “A” that has obtained capital funds by means of two latent assets consisting of stocks and patent right pays utility fees (i.e., royalty) to the investment company in compensation for the capital funds. In the entrepreneur's side, the data concerned about that royalty is accumulatively stored in the sales management database 21 of entrepreneur client 20a, and simultaneously transmitted to the investment corporate server 10, periodically (S304).

The investment corporate server 10 stores the data received from entrepreneur client 20a in the sales management database 14. Then, the trust property is managed using this data. That is, the control part 17 of the investment corporate server 10 performs the above-mentioned income-and-expenditure calculation and the risk operation based on the sales management database 14. Then, it estimates a royalty income, capital gain, or the like for the venture business group “A”. The obtained results are pooled in the sales information database 15 and the above-mentioned risk-management procedure is performed using the pooled data. Then, profit-and-loss are adjusted (adjustment of a royalty income). Simultaneously, the data obtained as a result of risk-management processing is stored in the risk-management database 16.

Therefore, even if a bankrupt company and/or a company being failed in business are included in the venture business group “A”, any loss caused by such failures can be diverted and diluted. In addition, adjusting the following items allows the control of an earning rate. That is, the items include: the total royalty amount with respect to the above license; and the royalty income of the living dead company in which the business performance and the sales are fixed.

Moreover, fixed profits can always be expected by analysis of the accumulation data in the investment corporate server 10. Therefore, a consolidated investment beneficiary right (beneficiary right about the total unrealized profits of the estimated amount of royalty and the estimated amount of capital gain) can be pooled, and the packaged transfer can be carried out to the special purpose companies, such as a financial institution.

The investment corporate server 10 creates and pools the data about a consolidated investment beneficiary right (unrealized royalty profits and unrealized IPO profits) based on the received data. Then, the packaged transfer of the consolidated investment beneficiary right is carried out from an investment company to a financial institution in every predetermined period. The data pooled with it is transmitted to the financial institution server 30 (S305). A financial institution plans and develops an investment beneficiary certificate (a financial product) on the basis of the assigned consolidated investment beneficiary right. The investment beneficiary certificate is complemented with trust by setting up a priority beneficiary right and a subordination beneficiary right. Next, the Web page of the information for the security sales about the developed investment beneficiary certificate is created. In order to answer to the demands from the investor client 40 of the institutional investors and individual investors, which are received through the communication network, the created Web page is offered (S306). When an investor wishes to purchase the financial product shown in the information for security sales, an appropriate purchase application form is acquired from the financial institution server 30 using the investor client 40. After entering predetermined application information in this form, it is transmitted to the financial institution server 30.

The financial institution server 30 determines on the sale of a financial product based on the received purchase application information. Then, the financial institution server 30 selects a suitable response from the reply information being stored beforehand and transmits the response that informs about the result of the above decision to the investor client 40.

By the sales transactions on this Web, a financial institution acquires the sales amount of an investment beneficiary certificate (S307). This amount is paid to an investment company (S308). The information about this payment is transmitted to the investment corporate server 10 from the financial institution server 40. The investment corporate server 10 manages the received information about the income based on the consolidated investment beneficiary right as information about the capital which is invested to other enterprises.

By such packaged transfer of a consolidated investment beneficiary right, an investment company can raise the funds for reinvestment capital. Then, the investment company uses the income based on the consolidated investment beneficiary right acquired by repeating the process of above-mentioned (S305 to S308) for the reinvestment to venture business group “B” which applied for financing with the new investment issue (S309). In this reinvestment, since the process having been mentioned above (S301) is repeated, subsequent explanation is omitted.

The above-mentioned procedure enables the increase in efficiency of the capital investment by capital liquidation and securitization mobilization. Moreover, earning capacity rises with the above-mentioned procedure. Therefore, the risk to the initial investment (initial capital injection) is reduced. Moreover, the “law of large numbers” can be occurred accompanied with accumulated investments, simultaneously with the risk hedge of both an investment and a reinvestment. Therefore, the investment risk about the venture investment itself also decreases by carrying out indexation of the venture business portfolio. Furthermore, the promising venture business, which can be expected to grow, can receive secondary and third additional investments. Therefore, the possibility of going public for venture business can be raised as the so-called incubation functions, such as venture support and a consultant, are strengthened.

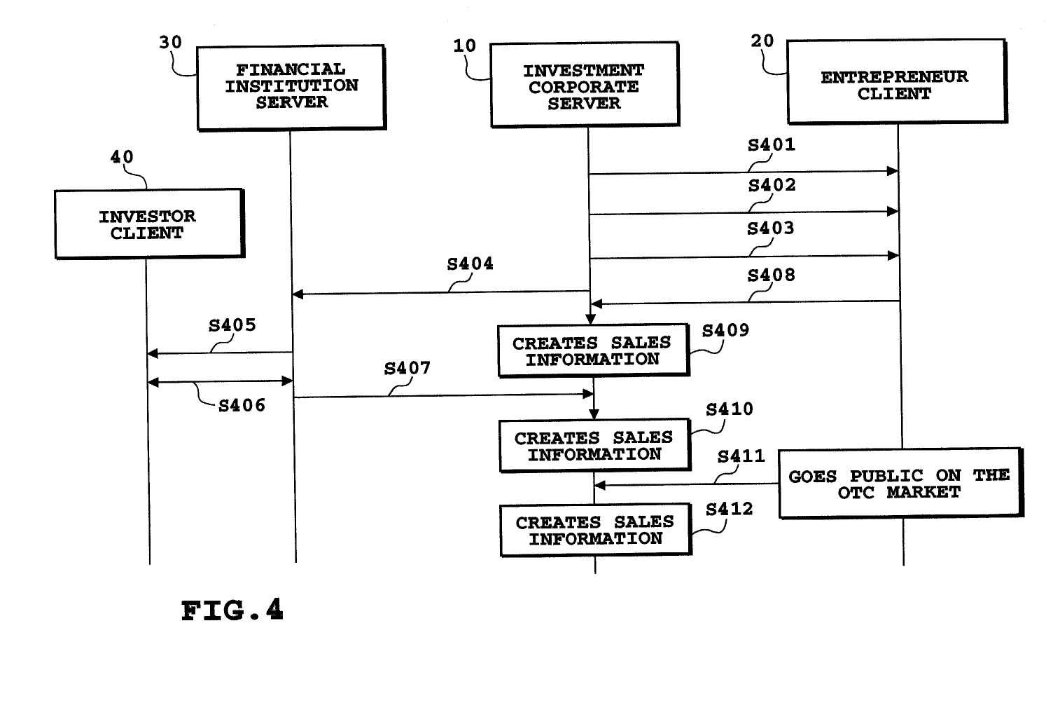

FIG. 4 is a block diagram that illustrates an example of the communication sequence in the procedure of investment securitization in accordance with the present embodiment.

First, a fiduciary trust contract, an equity instrument, and an enforcement contract are concluded between the investment company and the entrepreneur. Then, the contents on these contracts are transmitted to the entrepreneur client from the investment corporate server 10 for a check on those contracts (S401, S402, S403). Then, the entrepreneur carries out an enterprise and pays the royalty in proportion to the sales to the fund donor. It is transmitted to the investment corporate server 10 (S408), and the information about the amount of royalty is stored in the sales management database 14. The investment corporate server 10 searches for the sales information, and stores it in the sales information database 15 (S409).

Subsequently, the fund donor combines the beneficiary rights about an equity instrument and an enforcement contract into a consolidated investment beneficiary right, and then transmits the information about the consolidated beneficiary rights to the financial institution server 30 (S404). In the financial institution, a security is developed based on the information being received by the financial institution server 30. In order to sell such security to an investor, the sales information on the security is created and provided to the investor client 40 (S405).

When the investor wishes to purchase the financial product that relates with the sales information, transmission of the application for the purchase to the financial institution server 30 is performed from the investor client 40. The financial institution server 30 answers to this application, and transmits a reply to the investor client 40, and a sales agreement is concluded (S406). Thereby, while the consolidated beneficiary right is transferred to an investor, money is paid to the financial institution from the investor, and this money is crossed to an investment company. In this case, the information about the amount of money transfer is transmitted to the investment corporate server 10 from the financial institution server 30 (S407). The data received is stored in the sales management database 14. The investment corporate server 10 edits sales information, and then stores the obtained data in the sales information database 15 (S410).

On the other hand, although the capital gain income is paid to the fund donor when the entrepreneur begins going public over-the-counter, in this case, the information about the amount of capital gain income is transmitted to the investment corporate server 10 from the entrepreneur client 20 (S411), and subsequently stored in the sales management database 14. Furthermore, the investment corporate server 10 edits sales information, and stores it in the sales information database 15 (S412).

[Second Preferred Embodiment]

Regarding the privity of contract described above, its composition may be varied as its beneficiary differs. With this license form, a trust and banking company concludes the pension management contract of a beneficiary right with an investment company. Moreover, a trust and banking company serves as the common fund donor of patent-right trust. Here, this trust and banking company is the fund donor to whom management of 401K pension annuity is commissioned from the pension fund organizations. In pension management, reinvestment or securitization of an invested property is not carried out. Instead of this, “construction of the pension management structures and organizations that can make the profit realization stable in the long run” is needed.

That is, instead of an investor, a pension organization itself purchases an investment beneficiary certificate. When this pension organization employs a business annuity, there is a need to construct a new management organization. That is, this management organization must acquire the stable profit in the long run by the increase in efficiency of capital money employment. A trust and banking company (trustee who is entrusted with pension management from a pension organization etc.) raises new financial funds. That is, a trust and banking company takes over a consolidated investment beneficiary right after making an investment to venture business, instead of the special purpose company of FIG. 3.

This license form makes possible the profit realization which is stable in the long run with a little influence by fluctuations in stock market and economy. Moreover, “establishment of management organization” based on this license form needs a venture support network. This network is a supply chain that consists of required related different businesses.

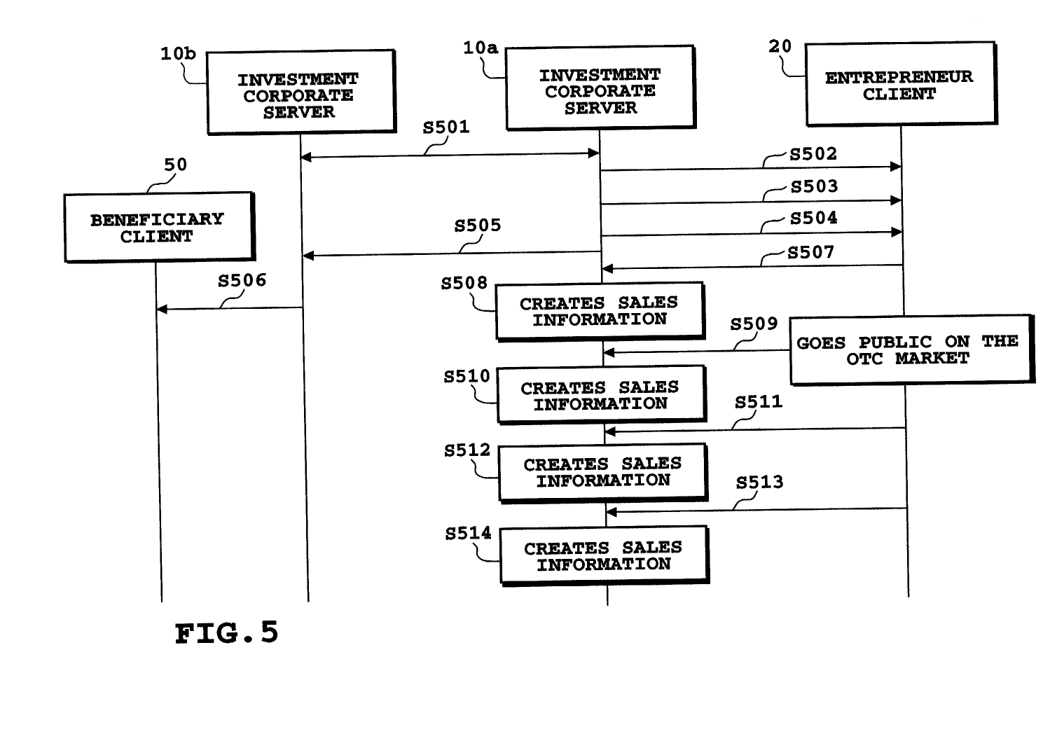

In FIG. 5, an investment corporate server 10a is one installed in the investment company. Moreover, an investment corporate server 10b is one installed in the trust and banking company. Furthermore, a beneficiary client 50 is provided as a client computer. This computer is installed in 401K pension organization who has commissioned the trust and banking company with pension management. The composition of a beneficiary client is the same as that of an investor client. Therefore, detailed explanation is omitted in the following description.

First, the transmission and receipt of data that shows the contents of a pension management contract are performed between investment corporate server 10a and the investment corporate server 10b. When they mutually agree on the contents of contract, the pension management contract is concluded between an investment company and a trust and banking company (S501). Subsequently, a fiduciary trust contract, an equity instrument, and a license contract are concluded between the investment corporate server 10a and the entrepreneur client 20. Then, the contents of the contract are transmitted to the entrepreneur client 20 from investment corporate server 10a for a check on that contract (S502, S503 and S504).

The fund donor makes a consolidated investment beneficiary right by consolidating together one beneficiary right based on the investment contract and another beneficiary right based on the license contract. An information about the consolidated investment beneficiary right is inputted to the investment corporate server 10a and is sent to the investment corporate server 10b (S505). The trust and banking company manages pension funds based on the consolidated investment beneficiary right using the information received by the investment corporate server 10b, and the pension administration is managed by the investment corporate server 10b. The beneficiary client 50 in the 401K pension organization receives information about the pension management which is periodically sent from the investment corporate server 10b (S506).

On the other hand, the entrepreneur carries out a business based on intellectual property rights. The royalty in proportion to the sales is paid to the fund donor. The information about the amount of this royalty is transmitted to the investment corporate server 10a from the entrepreneur client 20 (S507). The data received is stored in the sales management database 14. The investment corporate server 10 edits sales information, and stores the acquired information in the sales information database 15 (S508).

When the entrepreneur goes public, the capital gain income is paid to the fund donor. In this case, the information about the amount of the capital gain income is transmitted to the investment corporate server 10a from the entrepreneur client 20 (S509). The data received is stored in the sales management database 14. Investment corporate server 10a edits sales information, and stores the acquired information in the sales information database 15 (S510).

Subsequently, the information is transmitted about the capital gain income (S511). The data received is stored in the sales management database 14. The investment corporate server 10a edits sales information, and stores the acquired information in the sales information database 15 (S512). Moreover, the information about a dividend on stock is transmitted to investment corporate server 10a from the entrepreneur client 20 (S513). The data received is stored in the sales management database 14. The investment corporate server 10 edits sales information, and stores the acquired information in the sales information database 15 (S514).

[Third Preferred Embodiment]

In this embodiment, we will describe an example of concluding a sales agreement of financial product. That is, a financial institution divides one financial product into several products for concluding a sales agreement of each dividend product between the investment corporate server and the investor client.

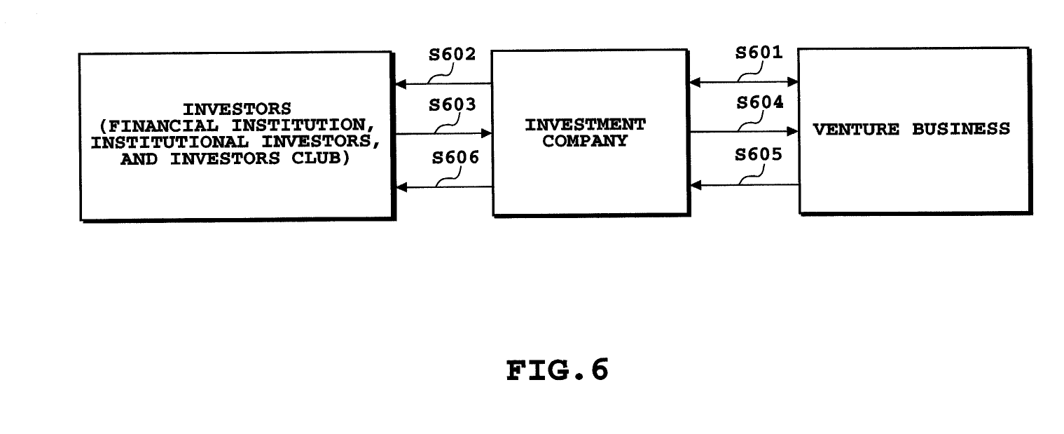

FIG. 6 is a block diagram that illustrates the procedure of the investment securitization business in accordance with the present invention. First, the venture business and the investment company, which are the parties concerned, permit or set up the following agreements to the venture business. The agreements include the fiduciary trust contract (managed type trust) of patent right of the venture business, the equity instrument with the purport that the fund donor acquires the stocks of the venture business, and the license contract based on the patent right already assigned to the investment company. The parties concerned and the venture business conclude a license contract. The contents of the license contract include that the venture business pays a predetermined rate of royalty to the parties concerned in proportion to the amount of goods sale or services offered in accordance with this license (S601).

A predetermined amount of fund established by the contract with the entrepreneur is invested to the venture business. In this case, the investment company establishes a predetermined amount of fund. The above-mentioned consolidated investment beneficiary right is divided in proportion to an investor's investment ratio in the fund. Subsequently, the divided financial products are sold to investors, such as a financial institution, an institutional investor, an investor club, and so on (S602). Therefore, the investment company receives the invested money obtained by sale (S603). The information about the invested money received at this time is stored in the sales information database 15 as information about a beneficiary right in the investment corporate server 10. The investment company then provides the venture business with the investment money (S604). Subsequently, the investment company receives a royalty income from the venture business (S605). The obtained income is paid out in every half a fiscal year or every fiscal year (S606). This dividends payment can be used as the above license form until two or more investment issues are collected and the securitization system of property asset gets off the ground. An example of the profit-and-loss calculation when an investment and a reinvestment are repeated in the investment securitization business on which the present invention is applied is shown in Table 1.

TABLE 1
Investment securitization enterprise, “A
profit-and-loss trial salculation in the investement and
reinvestment process”

| | | | Present |
|---|---|---|---|
| | | | investment |
| | Initial | Secondary | union |
| | investment | investment | system |
| Fund subscription | 1 billion | 2 billions | 1 billions |
| principal | | | |
| Fund proceeds | −4 billions | −8 billions | (during 10 |
| principal | | | years) |
| Accumulated | 4 billions | 8 billions | 1 billion |
| investment amount | | | |
| (4 rotation | | | |
| employment) | | | |
| The number of | 200 | 400 | 50 |
| invested | | | |
| companies | | | |
| accumulated | | | |
| The number of | 140 | 280 | 35 |
| benkruptcy and | | | |
| failure-of- | | | |
| business | | | |
| companies (70%) | | | |
| The number of | 60 | 120 | 15 |
| survivor | | | |
| companies (30%) | | | |
| The number of | 48 | 96 | 12 |
| living dead | | | |
| companies (24%) | | | |
| The number of | 12 | 24 | 3 |
| companies going | | | |
| public on the | | | |
| over-the-counter | | | |
| market (6%) | | | |
| Second and third | 1.2 | 2.4 | 0.3 |
| additional | billions | billions | billions |
| investments | | | |
| IPO profit (sum of | 12 billions | 24 billions | 3 billions |
| 12 companies) | | | |
| Royalty profit | 3.6 | 7.2 | None |
| (dividend) | | | |
| Total investment | 15.6 | 31.2 | 3.0 |
| profits | billions | billions | billions |
| Total profit- | 13.4 | 26.8 | 1.7 |
| and-loss | billions | billions | billions |

[symbol]

1. The amount of royalty profits is assumed 3 times the amount of investment (2 times assumed is also possible). [symbol]
2. The first investment. 20 millions yen is assumed per one company. [symbol]
3. IPO profit, 1 billion yen is assumed per one company going public on the over-the-counter market (second and third additional investment is 0.1 billion per one company). Prospect companies which have a possibility of going public are selected from survivor companies. Second and third additional investments are performed respectively.

Table 2 shows an example of allocating the priority beneficiary right and the subordination beneficiary right, when assuming the total profit-and-loss of initial investment is 13.4 billions yen.

TABLE 2
Allocation of priority and subordination
beneficiary rights (total profit-and-loss of 13.4 billion
yen).

| | |
|---|---|
| Initial | Secondary |
| investment | investment |

(1) Special-purpose company (priority beneficiary right)

| | | |
|---|---|---|
| Fund's accumulated sales | 4 billions | 8 billions |
| proceeds (principal) | | |
| Fixed yield (annual | 2 billions | 4 billions |
| intrest rate of 10% × 5 | (assumed | |
| years) | interest rate) | |
| Redemption of principal | 6 billions | 12 billions |
| and interest by fixed | | |
| term-typed fund | | |

(2) Investment company (subordination beneficiary right)

| | | |
|---|---|---|
| Investment company | 7.4 billions | 14.8 billions |
| (profit based on | | |
| subordination | | |
| beneficiary right) | | |

[symbol]

1. The account items in a profit based on subordination beneficiary right: operational expenses and outscoring expense, distribution to contributories, and internal reserve (retained earnings).

In each of the above embodiments, the processings performed by the investment corporate server 10, the entrepreneur client 20, and the financial institution server 30 or the like can be stored as a program in a recording medium such as CD-ROM, DVD-ROM, or hard disk, or in a transmission medium such as digital stream. The program can be executed by loading it to a memory of the computer or the like, every time it is required for individual devices.

In other words, the present invention can be implemented using any recording medium that stores a computer program to be loaded to and executed by CPU of the computer system. The program that defines each procedure in the present invention may be installed as one of various forms into the computer. One of such forms, for example, may be of a computer data signal or the like. It may be stored in an unwritable recording medium acceptable in the computer, such as ROM. Alternatively, it may be of digital stream or one ridden on a carrier wave, or may be of information to be transmitted through a communication network using a communication control device such as a modem. It is to be understood that the present invention is not limited to any particular form. Rather, the invention is more generally applicable to any form in which it is desirable to implement the present invention.

In the above described embodiments, the information presentation and communication are performed between the server and the client by means of the Web page. According to the present invention, it is not limited to such a method.

Moreover, in the above described embodiments, the intellectual property right owned by the venture business (the entrepreneur) is the patent right. According to the present invention, the intellectual property right may include, but not limited to, an utility model patent, a design, a trademark, a copy right, a business know-how, or the like.

Alternative ways may include an electronic mail and facsimile, which can be used for an application for financing from the entrepreneur to the fund donor, the notice of an examination result to an applicant from the fund donor, and provision of the sales information on the financial product to an investor from a financial institution.

Moreover, the various networks other than the Internet, such as a pay phone network and a leased line net, can be used as a communication network for the investment securitization system on which the present invention is applied.

Furthermore, in the above embodiments, these embodiments are implemented independently from one another, According to the present invention, however, it is not limited to such cases. A person skilled in the art will easily appreciate that any particular embodiment described herein can be carried out in combination with at least one of other embodiments.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A method of investment management for managing an investment to a business to be performed by an entrepreneur using an intellectual property right, comprising the steps of:
storing information about a beneficiary right in a first server computer, wherein the beneficiary right is based on the intellectual property right transferred from the entrepreneur to a fund donor in exchange for funds to be provided to the business and supplied by the fund donor; and
performing an income estimation about the investment to the entrepreneur at the first server computer on the basis of the information about the beneficiary right stored in the first server computer and information about proceeds of the business of the entrepreneur received from a fist client computer.

2. The method of investment management as claimed in claim 1, wherein
the beneficiary right includes a right to receive a royalty from the entrepreneur under a license being granted to the entrepreneur on the basis of the intellectual property right being transferred to the fund donor.

3. The method of investment management as claimed in claim 1, further comprising the step of:
notifying to the first client computer that processes the information about the entrepreneur before the intellectual property right is transferred from the entrepreneur to the fund donor, wherein the notifying step including the steps of:
the first server computer receives an application for financing to the business of the entrepreneur from the first client computer, and
the first server computer transmits notice information chosen from two or more notice information for notifying a corresponding examination result about the application to the first client computer, wherein the two or more notice information for notifying the respective examination results is previously stored in the first server computer.

4. The method of investment management as claimed in claim 1, wherein
the information about the proceeds of business includes information about an income to be brought from the entrepreneur.

5. The method of investment management as claimed in claim 1, wherein
the step of performing the income estimation includes the step of calculating an estimated amount of the income to be brought from the entrepreneur.

6. The method of investment management as claimed in claim 1, wherein
the intellectual property right transferred from the entrepreneur to the fund donor is a target property of trust with the fund donor.

7. The method of investment management as claimed in claim 1, wherein
the first server computer takes charge of an income obtained by means of the beneficiary right as reinvestment capital funds for another business to circulate the income.

8. The method of investment management as claimed in claim 1, wherein
the information about the beneficiary right includes information about a fund that is established by the fund donor with respect to the beneficiary right on the basis of the intellectual property right transferred from the entrepreneur to the fund donor.

9. The method of investment management as claimed in claim 1, further comprising the steps of:
storing sales information about a financial product in a second server computer that processes information about a financial institution that supplies the financial product that is made from the beneficiary right transferred from the fund donor by means of processes of liquidating and securitizing an asset; and
transmitting the sales information stored in the second server computer to a second client computer that processes information about an investor.

10. The method of investment management as claimed in claim 9, further comprising the steps of:
receiving information on purchase application from the second client computer by the second server computer, wherein the purchase application is provided for the purchase of a financial product represented by the sales information transmitted from the second client computer to the second server computer; and
transmitting reply that corresponds to the purchase application provided for the purchase of the financial product from the second server computer to the second client computer, wherein the reply is chosen from a plurality of reply information by the financial institute, wherein the plurality of reply information is previously stored in the second server computer for the purchase application.

11. The method of investment management as claimed in claim 9, wherein
the beneficiary right transferred from the fund donor is a priority beneficiary right.

12. The method of investment management as claimed in claim 9, wherein
the financial product is a fixed interest security.

13. The method of investment management as claimed in claim 9,
wherein the beneficiary right transferred from the fund donor is an investment target property for pension fund management by the financial institution.

14. The method of investment management as claimed in one of claims 1 to 13, wherein
the beneficiary right is consolidated investment beneficiary right that further includes a beneficiary right on the basis of securities with stock instrument included issued by the entrepreneur.

15. An investment management server for managing an investment to a business performed by an entrepreneur using an intellectual property right, comprising:
a storage means for storing information about a beneficiary right based on the intellectual property right transferred from the entrepreneur to a fund donor and supplied by the fund donor in exchange for funds to be provided to the business; and
a calculation means for performing an income estimation about the investment to the entrepreneur on the basis of the information about the beneficiary right stored in the storage means and the information about sales proceeds of the business received from a fist client computer that processes information about the entrepreneur.

16. The investment management server as claimed in claim 15, wherein
the beneficiary right is consolidated investment beneficiary right that further includes a beneficiary right on the basis of securities with stock instrument included issued by the entrepreneur.

17. A financial transaction server that performs a processing about a financial institution that supplies a financial product based on a beneficiary right transferred from the fund donor in accordance with claim 15. comprising:
a storage means for storing a sales information about the financial product; and
a transmitting means for transmitting the sales information stored in the storage means to a second client computer that processes information about an investor.

18. The financial transaction server as claimed in claim 17, wherein
the beneficiary right is consolidated investment beneficiary right that further includes a beneficiary right on the basis of securities with stock instrument included issued by the entrepreneur.

19. An investment management system for managing an investment to a business performed by an entrepreneur using an intellectual property right, comprising:
the investment management server as claimed in claim 15; and
the financial transaction server as claimed in claim 17.

20. A computer-readable medium capable of configuring a first server computer that manages an investment to a business to be performed by an entrepreneur using an intellectual property right to perform a method of investment management, said method comprising the steps of:
storing information about a beneficiary right in the first server computer, wherein the beneficiary right is based on the intellectual property right transferred from the entrepreneur to a fund donor in exchange for funds to be provided to the business and supplied by the fund donor; and
performing an income estimation about the investment to the entrepreneur at the server computer on the basis of the information about the beneficiary right stored in the first server computer and information about proceeds of the business of the entrepreneur received from a fist client computer.

21. The computer-readable medium as claimed in claim 20, wherein
the beneficiary right is consolidated investment beneficiary right that further includes a beneficiary right on the basis of securities with stock instrument included issued by the entrepreneur.

22. A computer-readable medium capable of configuring a second server computer that performs a processing about a financial institution that supplies a financial product based on a beneficiary right transferred from the fund donor in accordance with claim 20 to perform a method of investment management, said method comprising the steps of:
storing sales information about a financial product in the second server computer; and
transmitting the sales information stored in the second server computer to a second client computer that processes information about an investor.

23. The computer-readable medium as claimed in claim 22, wherein
the beneficiary right is consolidated investment beneficiary right that further includes a beneficiary right on the basis of securities with stock instrument included issued by the entrepreneur.
